(19) United States
(12) Patent Application Publication
(10) Pub. No.: US 2009/0072426 A1
(43) Pub. Date: Mar. 19, 2009

(54) Fluid pressurized structural components

(76) Inventor: Michael Regan, Port Hadlock, WA (US)

Correspondence Address: MICHAEL REGAN, 291 W. HORTON ST., PORT HADLOCK, WA, 98339, US

(21) Appl. No.: 12/231,265

(22) Filed: Sep. 2, 2008

Related U.S. Application Data
(60) Provisional application No. 60/993,975, filed on Sep. 17, 2007.

(51) Int. Cl. B29C 44/12

(52) U.S. Cl. 264/45.3

(57) ABSTRACT

The instant invention employs the impressive capabilities of modern materials such as plastics, composites, and metal alloys of carrying large tension forces, enabling them to carry compression loads by converting the compressive force of internally contained pressurized fluids into distributed tension forces. The walls and membranes of the pressurized elements, and of the envelopes are not “inflated” as in structures made of flaccid or stretchable materials, but are made of substantially rigid materials whose rigidity is enhanced by the fluid pressures contained within. An important application of the principals set forth herein will be in the use of very high tensile strength materials such as titanium or aluminum that are not often considered for use in compression. The significant weight-savings so achieved make possible new applications that might include exotic airframes: lighter-than-air craft, or small robotic solar-powered aircraft to be used for survey, surveillance, or communication.

A method for creating structural elements, members, and components effecting high rigidity and strength-to-weight by means of the containment and pressurizing of internal fluids.

### FIELD

Devices to be used as load-bearing members in structures such as aerospace and water-borne vehicles, bridges, furniture, buildings, etc., capable of supporting large forces for a given self-weight. This is the full application for Provisional Patent Application No. 60/993,975

### PRIOR ART

Modern society requires and produces a large number of items and structures requiring support members capable of carrying compression, torsion, etc, without having the high weight typical of compression materials. To fill the need, materials science has developed innumerable materials, both synthetic and natural, including plastics, metal alloys, ceramics, and composite materials in great varieties.

In all structures, the forces resolve themselves into lines of tension and compression in which, for every tension force in a structure, there exists an equal and opposite compression force. One of man's earliest discoveries was that stone could carry a great amount of compressive force. Stone, however, is very heavy, and is unsuitable for carrying tension. Wood has strength sufficient for both compression and tension, and can be used for applications such as the horizontal timbers in buildings. Generally however, to support compression loads requires a material of higher weight to strength, compared to those that carry tension. Alloys of metals have been made to carry increasingly large amounts of tension, but the strength-to-weight of compression materials has only been improved incrementally. Builders of bridges, cars, bicycles, and aircraft, to name a few, are constantly seeking ways to make their products lighter and stronger, to carry the necessary loads without an appreciable amount of self-weight.

The use of flaccid materials such as rubber to make inflated structures capable of carrying compression loads is well-known in the art. (U.S. Pat. No. 437,831 to John Dunlap, Pnuematic tires.) Also, regarding the use of textiles, see a paper written on the STRENGTH OF INFLATABLE FABRIC BEAMS AT HIGH PRESSURE 43rd AIAA/ASME/ASCE/AHS/ASC Structures, Structural Dynamics, and Materials Con 22-25 April 2002, Denver, Colo. C. Wielgosz, J. C. Thomas, P. Casari Laboratoire de Génie Civil de Nantes—Saint Nazaire Faculté des Sciences et des Techniques, Université de Nantes 2, rue de la Houssinière, BP 92208-44322 Nantes Cedex 03, France. See also their references: The authors present some mathematical methods for calculating more predictively the strengths achievable at the pressures in the inflatable structures they examined. Some of these mathematical models may be useful when redesigned to apply to the rigid material high pressure structures such as those disclosed herein, but such adaptation of these models will encounter some hurdles when accounting for the rigidity of the materials and multiple pressurized elements proposed herein. Myriad inflated structures, such as air-mattresses, life-rafts, even space craft, are also well-known in the art, but it is to be emphasized that the instant invention does not relate to such inflated structures, but is a means of enhancing the load-bearing capability of already rigid materials.

Other patents relating to gas pressurized structures also turn out to be inflated: U.S. Pat. No. 3,957,232 to Sebrell, U.S. Pat. No. 3,393,479 to Sletnick, U.S. Pat. No. 3,973,363 to Robert Josse LaPorte, Pierre Maurice Malachard DES Reyssiers, U.S. Pat. No. 511,472 to Sumovski. Various patents to Alvin Edward Moore, U.S. Pat. Nos. 3,716,953, 3,510,893, 3,774,566, and 3,559,920 describe ways of making vehicles such as cars, boats and planes using inflatable tubular structures in order to make the vehicles crash-proof. These involve various packagings of multiple cylinder structures, but again employ the use of inflatable, flaccid skin materials, and are applied in limited ways.

Since there are now so many kinds of rigid materials capable of carrying high tensile stresses, it would be useful if the capability of carrying high tension loads could be redirected to carry compression loads, so that structures could withstand a variety of forces. The instant invention supplies an answer to the problem of making lightweight structural members by capturing and redirecting the compressive forces inherent in gaseous and other fluid substances at high pressure within cellular elements composed of substantially rigid high tensile strength materials.

### SUMMARY

The instant invention relates to lightweight fluid pressurized structural components made of rigid material to be used primarily under compression and to act as members integrated within larger structures. They are composed in a cellular fashion, the most basic of the cells being pressurized elements of near-spherical proportions, oriented to improve the load-bearing capability of the larger structures in which they are contained. Some of the structures are of an elongated configuration, intended to support compression loads along a linear dimension substantially greater than their girth. Yet others are formed from combinations of these, or are intended to carry more broadly distributed forces, such as those of a roof or wall, etc. To enable these rigid, substantially hollow structural members to support the most compression with the least weight, they are filled with gases or other lightweight fluids maintained at higher than ambient pressure.

The subject matter of the present invention is particularly pointed out and distinctly claimed in the concluding portion of the specification. However, both the organization and method of operation, together with further advantages and objects thereof, may best be understood by reference to the following description taken in connection with accompanying drawings.

### DESCRIPTION OF THE DRAWINGS

FIG. 1 is a single fluid pressurized cylinder.

FIG. 2 is a fluid pressurized conical element, and elements with abutted cones and cylinders.

FIG. 3 is a pressurized structure made with two cylinders inside an envelope.

FIG. 4 is a collection of pressurized structures using various groupings of cylinders inside envelopes, some of which are shown in cross-section only.

FIG. 5 is the preferred embodiment: a cylindrical casing with a stack of pressurized cannisters inside it, or alternatively, a banded pressurized cylinder.

FIG. 6 is an example of a close-packed bundle of pressurized cylindrical structures of different diameters, forming a rounded square in cross-section.

FIG. 7 is a pressurized spherical element, and close packings of spheres.

FIG. 8 is three examples of structures composed of pressurized elements.

### DETAILED DESCRIPTION

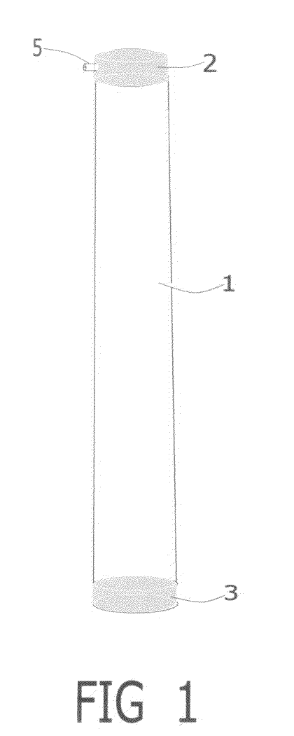

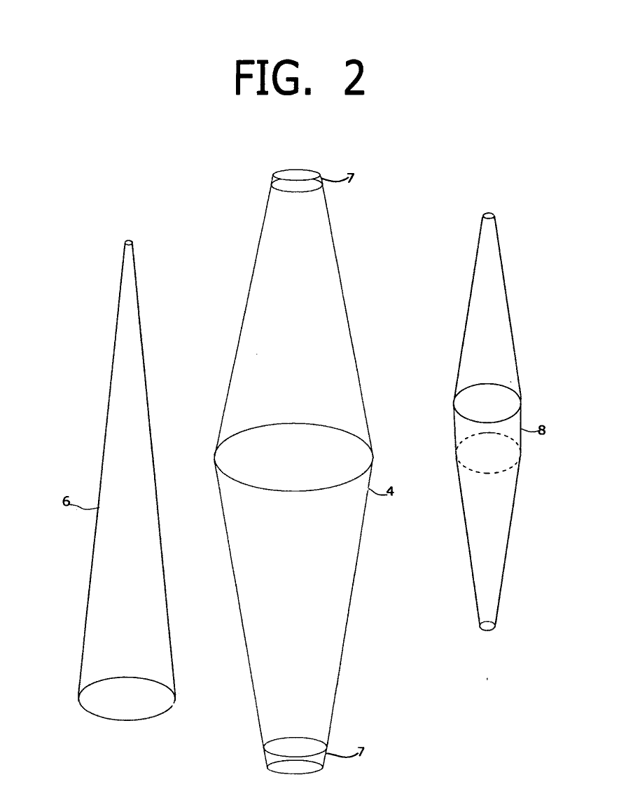

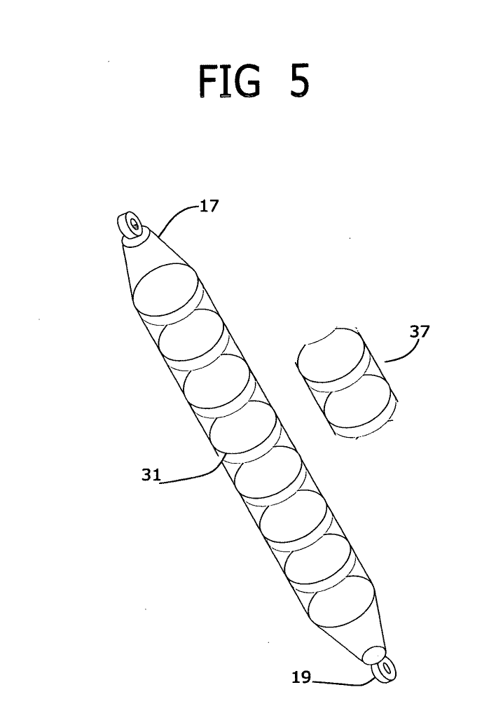

Now referring to FIG. 1, the simplest axially-oriented shape for a pressurized structural element is cylindrical, which is a special case of conical. In a fluid-pressurized cylinder, a circumferential tension force is exerted on the walls as the fluid's molecules collide with them, and an equal force per square inch is exerted longitudinally, due to the molecules colliding with the ends of the cylinder. Stiffening effects resulting from such forces enable the element to carry greater loads than would be possible without those pressurized fluids. This simple pressurized structural element consists of: a pressurized cylinder 1, with end caps 2,3 having a means of attachment to other structures, and optionally, a valve 5 or other means of assessing or altering fluid pressure. Though a single pressurized strut may be of greater size longitudinally than laterally, (higher aspect ratio) for use as an elongated compression member within a structure, a shorter version of the same cylinder, as well as other variations, may be stacked within a casing, forming a cellular assembly as described herein FIG. 5.

Now referring to FIG. 1, in an example such as a typical bicycle frame made of rigid tubular high tensile metal alloy, the strength of the frame would be increased if the framing tubes were only sealed and pressurized. The metal walls could then be made of thinner material, to reduce the weight. If pressurized gases are used, the actual weight of the additional gas needed when under high pressure is minimal compared to the gain in strength-to-weight ratio.

Lightweight fluids such as hydrogen or helium may be used, but the permeability of the pressurized structures needs to be taken into account. A commonly available fluid, nitrogen, would be suitable for most applications, because it remains gaseous at extremely high pressures and low temperatures, and its molecules are too large to permeate through a wide variety of substances. The type of fluid to be used will depend upon the temperature and external pressure conditions the structural member is expected to be exposed to, so the fluid will be selected from the class of molecular and atomic fluids, such as N2, CO2, He, H2, Ne, Ar, etc. Some of the applications of the components described herein will require fluid pressures of more than 20 times that of atmospheric pressure at sea-level, and many are expected to be even greater than 100 times atmospheric. Substances which are liquid under the necessary pressures may be appropriate for certain applications such as uses underwater, though the instant invention largely makes use of gaseous substances, because of the advantages of their low weight.

Now referring to FIG. 1, the structural members may have a wide range of aspect ratios (length divided by average diameter) depending on the chosen uses. One way to increase the strength-to-weight ratio for a given span and compression load is, for example, to widen the diameter of a cylinder while decreasing the wall thickness. For particular loads and spans, an ideal balance between pressure, diameter, and wall thickness will be found for each type of material and durability demands, and ambient conditions. A very thin-wall tube (of a titanium or aluminum alloy, for example) that would never be considered in an application requiring high modulus or compression-load bearing, could be pressurized to the point nearing, say, 75% of its safe working tensile load and could then be used to bear compression loads, or as a member in combinations as described herein. It is necessary that containment elements be circular, at least in cross-section, since the fluid pressure pushes outward evenly in all directions. In order to embody configurations other than cylindrical, conical, toroidal, or spherical, these round containments may be fit together in cellular fashion in combinations, as follow.

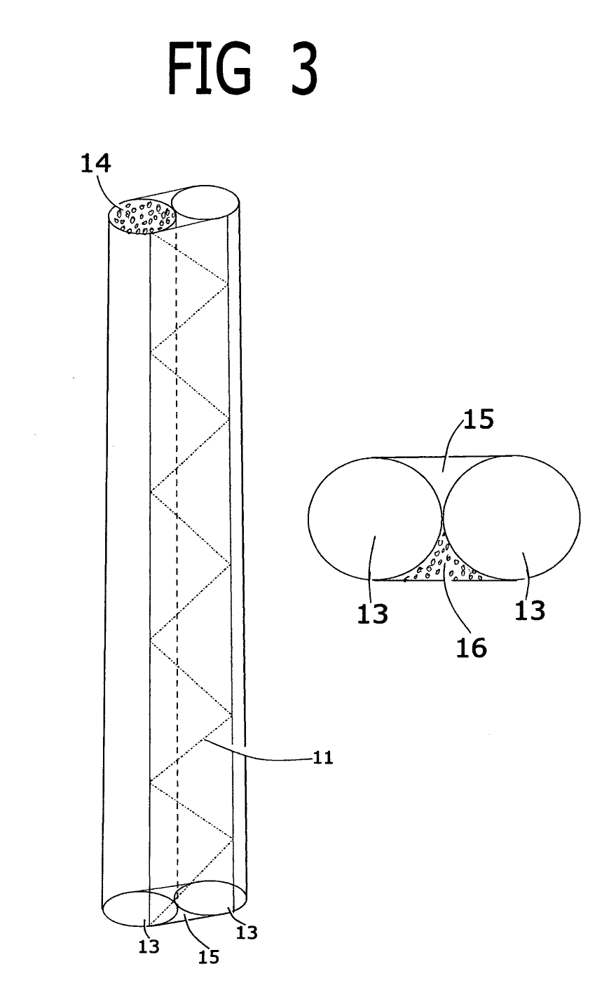

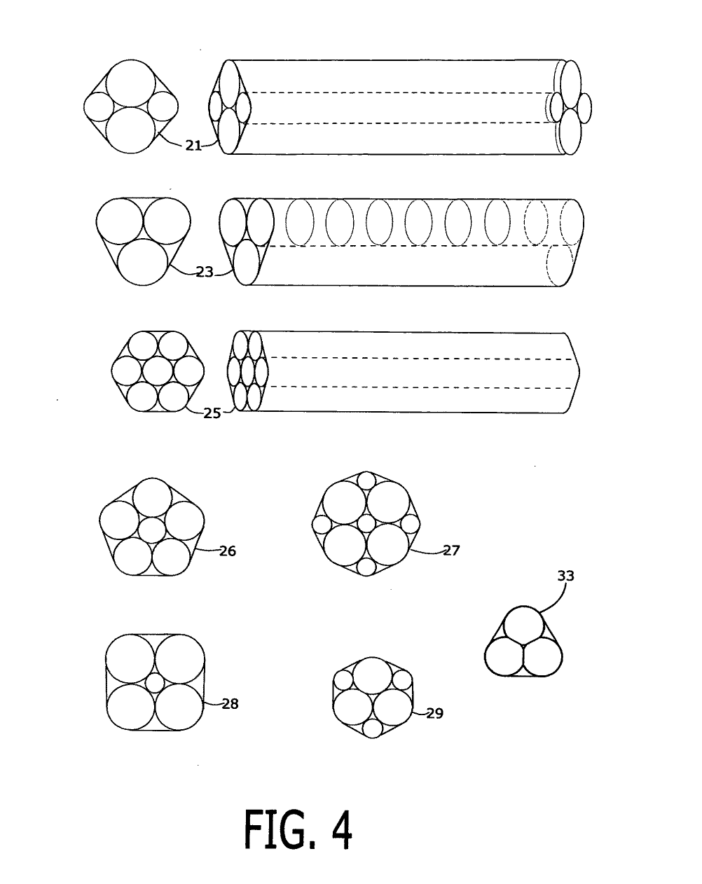

Now referring to FIG. 2, a compounded cone arrangement 4 in which two elongated hollow cones attached end to end is a modification which makes a structural member somewhat more spherical. It achieves a widening at mid-span without resorting to compound curvatures. Strength is greatly increased because tendency for buckling is reduced, and the fluid is also colliding on the walls in such a way as to create longitudinal force. The ends 7 may have special flanges added for stacking with other cones or cylinders, or may have a means of attachment FIG. 5: 17,19 to other structures. Spanning length and other modifications may be achieved by fitting additional conical or cylindrical elements between the two cones 8. Single conical elements 6 may also be used singly or for applications where they are packed into envelopes or casings, similar to those described below and depicted in FIG. 3 and FIG. 4 for cylindrical elements.

Now referring to FIG. 3, another modification is to bundle two or more cylindrical or conical elements inside some additional high tensile strength material made into an envelope configured to fit them tightly, so that the pressure inside the cylinders or cones serves to tension the envelope. This outer envelope is thus stiffened, and its ability to carry axial loads is improved by the lateral pressures exerted on it by the pressurized elements on the inside in a way similar to that in which the cylinders themselves are stiffened by their internal fluid pressure. In the case of two cylinders, the cross-sectional shape is substantially oval, having two semi-circular ends, and two flat sides. By bringing these flat sides into tension, the fluid pressure creates stiffening due to the triangulation effects arising across their tensioned faces 11. When in such tension, these faces work effectively in the same way as the faces of a truss. Structural members with bilateral symmetry, being stiffer across one lateral direction than the other, can be used in structures designed to hold the cross-forces in place in a way similar to that in which 2×4's are held from cross-buckling by plywood in the example of conventional wood-framed houses. They may also be stacked, face-to-face, to form broader struts, or wall-like structures. However, it may be advantageous in many circumstances to bundle the cylinders and/or cones in symmetrical groupings, as in FIG. 4.

Now referring to FIG. 3, in a multiple-element structure, there can be several layers of interior space: the primary spaces 13 are those within the elements, and the secondary spaces 15 are those between the elements and the envelope. If the secondary spaces are maintained at higher than ambient pressure, it becomes possible to maintain higher than rated fluid pressures inside the elements, because the crucial number is actually the fluid pressure differential between the interior and exterior of the pressurized element. Though the stiffness of the individual cylinders in this example is only marginally, if any, more than it would be without the additional pressure in the secondary spaces, the modulus of the structural member as a whole is improved, due to the added tightening on the envelope walls. It is not recommended that the full tensile capacity of the structural materials be too closely approached, as it is likely to then be exceeded when compression force is applied.

Ideally, certain special fluid substances could be used which are capable of maintaining a nearly constant pressure as external temperature and pressure conditions change. For most situations on earth, the atmospheric pressure variations between sea-level and high altitude are minimal, compared to the fluid pressures expected to be contained inside the members. However, temperatures can vary enough in extreme conditions to make a significant effect on the pressure difference between the interior and the exterior of the members. Therefore, a fluid like nitrogen is recommended for most conditions, because it is unlikely to condense in the normal range of earth-like temperatures and expected pressures, and may also be viable for use in outer space. For some situations, a means of applying heat may be employed to maintain adequate internal pressure under loads.

It is recommended that the materials used for the cylinder or internal element and the envelope walls be of consistent, uniform thickness. Nevertheless, greater strength to weight ratios may be achieved, even in components made with less precision, with the introduction of internal pressurized fluid. The materials will be chosen from a class of rigid, high tensile strength metals such as aluminum, steel, titanium, magnesium, or their alloys, or rigid plastics, such as polypropylene, polybutene, or composites, etc.

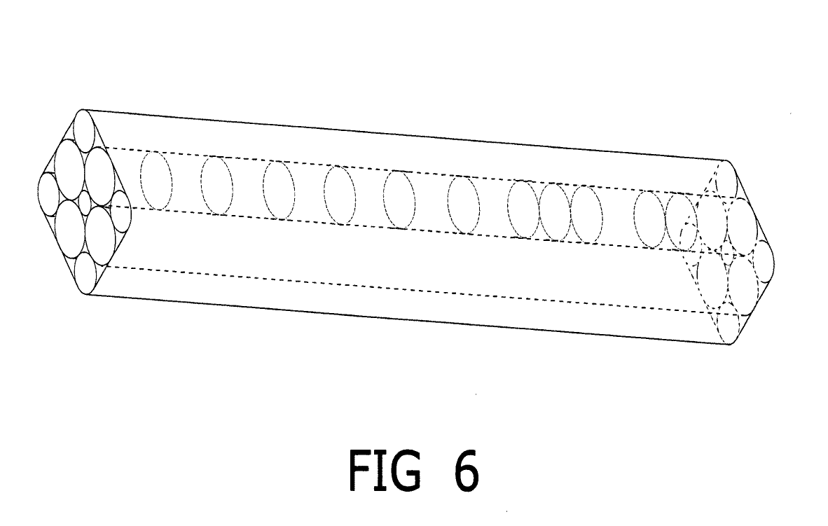

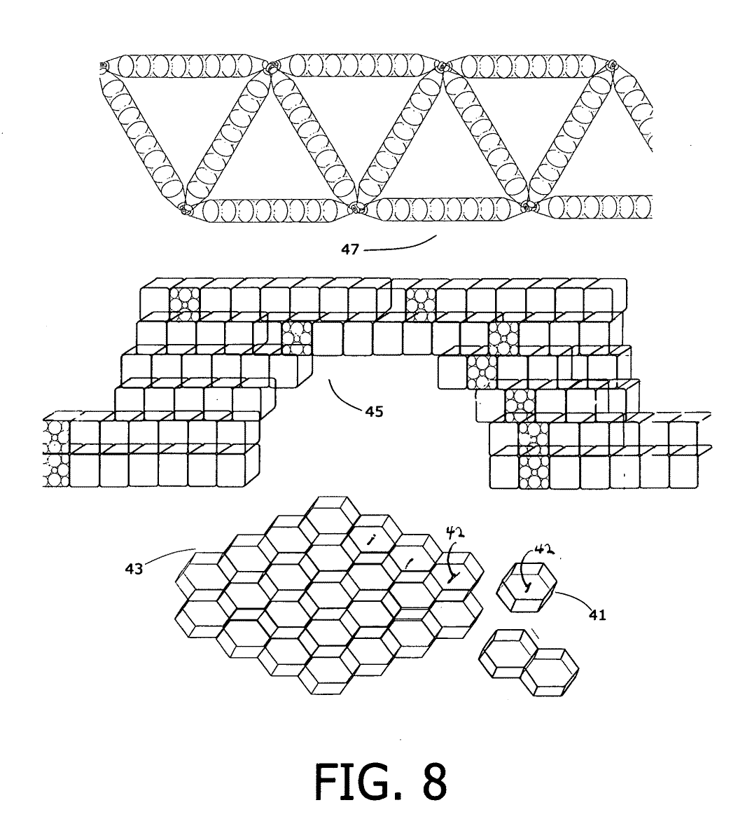

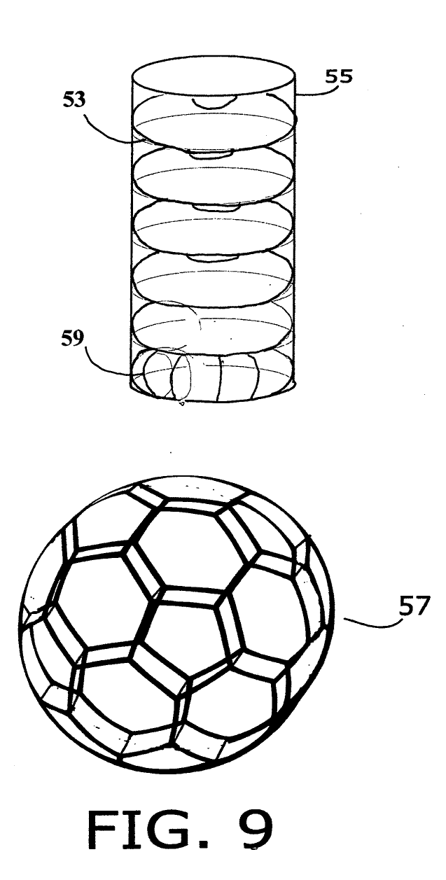

Now referring to FIG. 4, the cross-sectionally symmetrical structural members resist bending equally in many directions. Multiple-cylinder structures need not be limited to equal-sized cylinders. The four-cylinder member 21 is made with two large and two small cylinders, with an envelope of approximately rhomboid cross-section. Though it has only a bi-lateral symmetry, the example illustrated is nearly balanced in four directions. The envelopes around these multiple-cylinder structural members again have flat sides, each of which when tightened, makes the truss-like effect as in the two-cylinder embodiment, above FIG. 3: 11, thus giving them the same stiffening effect, but in many directions, not just two. In cross-section, the symmetrical versions appear as regular polygons with rounded corners. Arrangements of cylinders in combinations of different diameters within an envelope can be made having sharper corners, where the envelope wraps around smaller diameter cylinders, FIG. 6. Thus, the breadth of the flat parts of the envelope walls can be greater with respect to the average diameter of the bundle as a whole. Such sharper-cornered square packings can then fit, for example, within the square cross-sections of a conventional triangulated trusses, forming a hybrid truss strengthened by the use of fluid-pressurized cylinder bundles. This method will also apply to other cross-sections, such as triangular, hexagonal, etc. Elements may also be used having curvatures slightly flattened at areas where they are packed or nested against each other 33. The bundled pressurized elements may also be layered to form planar arrays FIG. 8: 45.

Now referring to FIG. 6, cylindrical elements packed into an outer envelope exert large distortion forces against the envelope when forces are applied that tend to bend them, or flatten them at bending areas. When the cylinders inside envelopes have high internal fluid pressures, any bending effects create greater total fluid pressure changes than occur in single cylinders, because there are several cylinders experiencing flattening forces at once, seeking room in which to widen against each other, and against the envelope. In addition, if the envelope is in cross-section a rounded square, FIG. 6 it behaves holistically like a square cross-section truss.

The stiffness of a fluid pressurized device, as measured by its resistance to buckling under longitudinal compression, is dependent on its over-all configuration, and the direction in which force is acting upon it. Since the instant invention relies on tension to increase stiffness, it would be advantageous in many cases if volume containers were spherical, or near-spherical with the forces acting on them tending to deform away from spherical, or away from their most efficient volume containing shapes, even though such deformations will occur within a narrow range, due to the substantially rigid nature of the materials intended to be used.

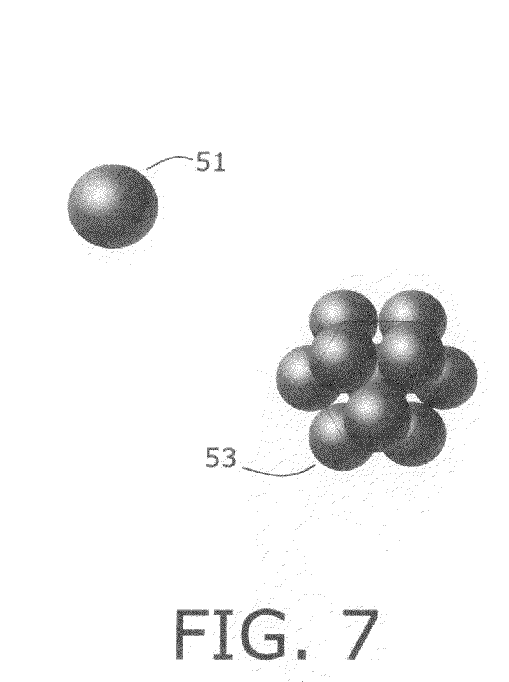

Now referring to FIG. 7, the first in geometric simplicity is spherical 51. It is omni-directionally symmetrical, and is also the shape with maximum volume per surface area. This shape would carry a theoretical preference if it were required to carry omni-directional forces, but a requirement for most applications herein is that the structural members carry a longitudinal force, or other forces in pre-determined directions. One application of a unitary pressurized sphere would be to use it as a ball-bearing, where the loads may be from any number of polar directions, but not all at once. For a wider variety of load-supporting structures, a way to make them as rigid as possible is to fill them with spheres in closest packing arrangements. Using a multiplicity of equal-sized spherical elements packed into hollow casings will create structural members whose cells are in predictable packing arrangements, such as the “face-centered cubic”, 53 as it is described in crystallography. In this packing each sphere is touching twelve others in a pattern wherein the centers of the 12 spheres correspond to the 12 vertexes of a cuboctahedron, and the lines of the cuboctahedron represent the joined radii of the touching spheres. The cuboctahedron being made up of octahedrons and tetrahedrons, the over-all grid is known as an oct-tet truss system, and it is the same as the arrangement of carbon atoms in diamonds.

In such a close packing, for every initial sphere there is one gap surrounded by six spheres (octahedral) and two smaller gaps surrounded by four spheres (tetrahedral). To place smaller spheres inside these gaps, setting the initial sphere radii equal to 1, the tetrahedral gap filling spheres would have radii of square root of 3/2, minus 1, or 0.22474487. The octahedral gap fillers would have radii of square root of 2, minus 1, or 0.4142136. It may be possible to achieve the proper arrangement of spheres by mixing all 3 sizes of spheres together in the given proportions, and just shaking the mixture until they settle into the closest packing network. One might also use a mixture of random-sized spheres, but the packing would not be predictable. This packaging procedure might take place inside a hyperbaric chamber, whose gas pressure is nearly equal to, but more than, the pressure inside the spheres. Then, when the sphere-filled member is removed from the chamber, the spheres will be exerting their pressurization forces against one another, and against the walls of the member.

Now referring to FIG. 5, the preferred embodiment, one way to achieve a packing of near-spherical elements in which the fluid pressure is evenly distributed would be to fit a stack of short, pressurized conical or cylindrical elements or cannisters, whose longitudinal measures are less than their diameters, inside an outer cylindrical casing. These elements should be oriented in such a way as to enhance this increase in stiffness by placing the shorter dimension in the same direction as the axis of the compression force. In such an embodiment, longitudinal compression causes immediate pressure increases in the cannisters 37, while distributing deformations more uniformly along the length of the device. The cannisters may be constructed or packed into the casings in such a way as to have a slight bulge in their end faces, in order to effect the momentary pressure increases desired under load. Pictured in FIG. 5 on the end of a casing containing a stack of cannisters is a conical pressurized segment, 17 with a means of attachment, 19, to other parts of structures. Another way to make an elongated structural member with the near-spherical elements, without using a stacking of cannisters, is by the banding of cylinders 31. One simply fastens tension bands, either straps, wires or like materials, circularly around a cylinder at intervals equal to or less than the diameter. The effect of this is to restrain the outward forces without the need for internal planar layers between elements. These cylindrical casings, banded or with stacks of short pressurized cylinders (cannisters) inside them, could then be bundled in close packing arrangements such as those shown in FIG. 4, to achieve the synergistic advantages formed by both the bundling of multiple cylinders, and the deformation resistance of banding or cannister stacking.

Now referring to FIG. 9, toroidal elements 53 may be used to great effect in supporting compression loads through their axial dimensions. They have the necessary cross-sectional circularity, and they have obvious advantages over the use of spheres in their ability to spread out the loads, being that they are already of a somewhat more spread out shape. A torus rests on a circular base whereas a sphere rests on a point. In addition, any distortion effects arising from compression loads acting axially on a fluid pressurized toroid tend to more rapidly cause a decrease in volume and a concomitant increase in internal fluid pressure, so that when the pressure is sufficiently high, rigidity is more fully maintained under loads. A torus has the dimensional characteristic known as aspect ratio, (circumference divided by girth) because it is topologically equivalent to a cylinder bent around into itself. Toroidal elements may be stacked in casings 55 to create elongated structural members in a way similar to that done for cannisters FIG. 5, and they may also be banded at intervals, or have cannister-like sealed elements 59 inside them.

There are several ways to manufacture pressurized structures, and they can be employed separately or in combinations. One is to build valves into the element and envelope walls, and to inject the fluids and foams into them after manufacture. A second way is to effect the final sealing of the elements, cylinders, toruses, cannisters, etc., and the casings or envelopes within hyperbaric chambers with the appropriate pressures. The elements could be sealed under a given pressure inside one such chamber, then inserted into the envelopes or casings, which are then sealed, possibly under another pressure, or in another chamber. Structures may be formed having more than two layers of different pressures. For a stack of cannisters FIG. 5, or toruses 55, a method may be to pressurize them in a preliminary process, then compress them longitudinally inside a cylindrical casing before final sealing.

Now referring to FIG. 3, it may be simpler to achieve the packing of pressurized elements if they are not all required to be of a set of equal diameters, or if there were some kind of filler material in the voids between them. An example of this occurs quite readily in foamed materials, such as gas-foamed plastic, metal, or glass. As an alternative to fluid pressure alone, a foamed material 14 may be injected into either the primary spaces 13 or into the secondary spaces, (voids) 15 or both, and itself either pressurized or left at ambient pressure. Due to their circular cross-sections, the stiffness of cylinders can be enhanced simply by the high pressures of internal fluids, and though the secondary spaces 15 within envelopes may be left unpressurized, they might be improved by the use of a filler. The best use of the foam, then, is to inject or otherwise place it into the secondary spaces, 16 which will tend to reduce distortions of the cylindrical and other elements when the structure is under a compression load. In addition, the foam can act as a padding between primary and secondary walls, and between elements, helping to prevent abrasion resulting from repeated stressing.

It may be very difficult to expand and permanently seal plastic closed cell foams inside elements while maintaining their internal pressures after cooling. Using metallic or glass media may be just as difficult, but the result could be of great value in creating the desired lightweight rigidity. One method may be to effect the sealing process inside of a hyperbaric chamber at high pressure. If a liquid medium intended to harden is injected into the structures in a liquid state, together with an expanding substance such as a gas, it will have to be at a pressure slightly higher than that of the hyperbaric chamber for the expansion to take place, and at some fairly high temperatures to maintain its liquid state Yet, some of its heat will have to be removed while the necessary pressures are being reached, or much of that pressure will be lost when the resultant structure is cooled. Also, one will need a medium which has a melting point which is lower than those of the structures inside of which they are to expand. After expansion, the pressure inside the structures may need to be maintained before they are sealed, and as the temperature is lowered, and the pressure gradually let out of the hyperbaric chamber, it is intended that a desired amount of pressure remains inside the structures.

A simpler method may be to create a multiplicity of gas pressurized micro-tubules or micro-spheroids out of one substance, and then embed these in another material or a medium to form a composite matrix which would contain the pressurized elements. The result would be similar to that of the containment of pressurized foam described above, but without the difficult thermal problems The diameters of these embedded pressurized tubules and spheroids may range from the very small, as measured in microns, to sizes measured from centimeters up to meters. An example might be titanium tubules or spheroids inside an aluminum encasement matrix.

Now referring to FIG. 8: a structural member 45 with substantially square cross-section can be formed by stacking substantially cubical cannisters either with a strong glue, or within a square casing. To prevent uneven forces being exerted on the exterior square faces by the fluid pressure, the cubical cannisters should be reinforced by containing other pressurized elements, as in FIG. 6. These composite members can then be further bundled within a larger envelope, forming a structure containing many pressurized cells. Such structures can then be layered to form planar arrays, which can be used to enclose volumes, or to span areas as for floors in buildings for example, or for pontoons, for beams or for component surfaces on vehicles, such as areas of auto bodies. Decks so constructed could be essentially self-supporting, requiring no additional external beams. Other pressurized structures, such as those in FIG. 4: 21,23,28,29 can also be layered and assembled in similar fashion. An advantage of stacking is that layers formed between the cannisters provide lateral tensioning at intervals equal to the cannisters' thickness, thus distributing the outward force of the fluid pressure throughout the length and breadth of the members.

Now referring to FIG. 8: planar arrays of attached pressurized elements may best be formed when they are polyhedral, or of cross-sectional polygon configurations that can tile the plane. An example already mentioned is that of the substantially cubical stackings. A planar composition of these is shown in FIG. 8: 45. Another arrangement suitable for making planar arrays, or sheets of pressurized elements, is the honeycomb type, made with packings of hexagons 43. Shown as item 41 is a single such cell. These may be formed of short segments of the bundled elements such as FIG. 4: 25. Or, a piece of tensile material 42 may be attached at the center of each hexagon cell, connecting the two opposite exterior walls, to restrict any tendency of the faces to bulge.

The fluid pressure of the nested cells is equal on both sides if the internal cell walls, and so does not contribute substantially to their individual rigidity. So the internal walls serve chiefly as tensile connections to create attachments at many points with the outer walls, redistributing and spreading out the forces exerted on the over-all structure. It should be noted that, when any two pressurized elements abut each other at shared faces, there is no differential of pressure at those faces, or walls, and some of that wall material could be removed without substantially affecting the over-all structural integrity of the member or component, providing that adequate tensile material is in place to hold those tensile loads previously held by the missing wall material. Such a procedure was described in relation to FIG. 5 in the banding of cylindrical elements as a replacement for stacked cannisters.

Now referring to FIG. 9: one application for such a planar array of fluid pressurized cells is that it be used to form a spherical shell. This is done by attaching variously proportioned hexagon and pentagon cells to each other in an arrangement like that of a soccer ball 57. Higher frequencies may be achieved wherein larger numbers of cells form the spherical shell by using mathematics and symmetries derived from those worked out for higher frequency geodesic domes. Such spherical shells may be ideal for lighter than air craft, because they would be able to maintain their rigidity without the need to pressurize their large interiors. In this manner the structures could also maintain non-spherical shapes such as hemispherical, because the cells themselves would support the necessary loads by means of their own pressurization.

### DEFINITIONS

Terms used herein are defined as follows:
Elements: The most basic of fluid pressurized structural components. These cross-sectionally circular bodies include the spherical, toroidal, conical, and cylindrical. Can be used in stand alone applications, or embedded inside larger components.
Members: Components for use in larger structures, usually elongated, as struts. Can be single elements, such as cones or cylinders, or compounded such as the stacked, bundled, or layered components.

Example: a simple cylindrical element is a member when it is part of an assembly such as a truss, but it is an element when it is bundled with other cylinders inside an envelope.
Casings: Containments inside of which elements are packed or stacked.
Stacked: Lined up axially and placed against each other to form elongated components, as with short cylinders, cones, or toruses stacked inside casings.
Envelopes: Containments inside of which cylinders, cones, or cylindrical or conical casings are bundled. Usually non-circular in cross-section, and having flat faces, these containers may be layered or further bundled to form larger structures.
Bundled: Cylindrical elements or members packaged side by side inside an envelope usually to form an elongated component.
Layered: Attached to each other where there are flat faces (of components such as the bundled, cubical, hexagonal or polyhedral), to form planar structures, such as planar arrays.
Micro-tubule: A fluid pressurized cylindrical or conical element, ranging in size from microns to meters, which can be embedded in a matrix containing other such elements within a ground substance.
Micro-spheroid: A fluid pressurized spherical or toroidal element, ranging in size from microns to meters, which can be embedded in a matrix containing other such elements within a ground substance.
Component: Any of the embodiments of the fluid pressurized bodies described herein.
Conical: Adjective for cone: A 3-dimensional shape which has a circular cross-section perpendicular to its axis. The straight lines on its surface intersect the circle, and may or may not intersect the axis.
Cylindrical: Adjective for cylinder: A special case of conical, where the lines on the surface are parallel to each other, and to the axis.
Cellular: Consisting of small compartments

I claim:

1. A load bearing structural component comprising fluid pressurized elements or members composed of substantially rigid materials.

2. The method in claim 1 wherein a multiplicity of fluid pressurized spherical said elements are packed within outer casings to form said structural members.

3. The method in claim 1 wherein a multiplicity of fluid pressurized cylindrical said elements are stacked within outer casings to form said structural members.

4. The method in claim 1 wherein a multiplicity of fluid pressurized conical said elements are stacked within outer casings to form said structural members.

5. The method in claim 1 wherein a multiplicity of fluid pressurized toroidal said elements are stacked within outer casings to form said structural members.

6. The method in claim 1 wherein fluid pressurized conical or cylindrical said elements are banded at intervals to form said structural members.

7. The method in claim 1, wherein a multiplicity of conical or cylindrical said elements or said members are bundled within outer envelopes.

8. The method in claim 7, wherein a multiplicity of said bundled elements, said members, polyhedral elements, or combinations thereof, are layered in planar arrays.

9. The method in claim 8, wherein fluid pressurized conical said elements, cylindrical said elements, spherical said elements, stacked said elements, toroidal said elements, polyhedral said elements, banded said members, bundled said members, layered said planar arrays, or the voids between any of said, are filled with a matrix containing pressurized micro-tubules, or micro-spheroids.

10. The method in claim 8, wherein fluid pressurized conical said elements, cylindrical said elements, spherical said elements, stacked said elements, toroidal said elements, polyhedral said elements, banded said members, bundled said members, layered said planar arrays, or the voids between any of said, are injected with a pressurized foamed material.

11. The method in claim 10, wherein said elements, said members, said stacked elements, said banded members, said bundled, said toroidal, said polyhedral, said layered in planar arrays, said foam injected, or matrix filled are formed and pressurized within a hyperbaric chamber.
